(19) United States
(12) Patent Application Publication
(10) Pub. No.: US 2010/0112404 A1
(43) Pub. Date: May 6, 2010

(54) FUEL CELL SYSTEM

(76) Inventors: Norio Yamagishi, Nishikamo-gun (JP); Yoshiaki Naganuma, Nissin-shi (JP); Kazuyuki Oikawa, Shioya-gun (JP)

Correspondence Address: KENYON & KENYON LLP, 1500 K STREET N.W., SUITE 700, WASHINGTON, DC, 20005, US

(21) Appl. No.: 12/532,975

(22) PCT Filed: Mar. 13, 2008
(86) PCT No.: PCT/JP2008/055156

§ 371 Date: Sep. 24, 2009

(30) Foreign Application Priority Data
Mar. 28, 2007 (JP) 2007-085548

(51) Int. Cl. H01M 8/04

(52) U.S. Cl. 429/26; 429/34

(57) ABSTRACT

An object of the present invention is to provide a fuel cell system capable of raising the temperature of a discharge valve and restraining the discharge valve from freezing by a simple structure. The fuel cell system has a circulation system for circulating hydrogen off gas, which is discharged from a fuel cell, to the fuel cell, an exhaust/drain valve for discharging a fluid passing through the circulation system to the outside, and a refrigerant flow path through which a refrigerant, which is circulated to the fuel cell, flows. The exhaust/drain valve has a valve body provided with a flow path which interconnects the interior of the circulation system and the outside. A part of the refrigerant flow path is provided by penetrating the valve body so as to be independent of the flow path.

### TECHNICAL FIELD

The present invention relates to a fuel cell system provided with a discharge valve for discharging a fuel off gas or a fluid containing generated water in a circulation system to the outside.

### BACKGROUND ART

Currently, a fuel cell system provided with a fuel cell which receives the supply of reactant gas (a fuel gas and an oxidizing gas) to generate electric power has been proposed and in practical use. For instance, the fuel cell system disclosed in Japanese Patent Application Laid-Open No. 2006-147440 has a circulation system which circulates a fuel off gas discharged from a fuel cell to the fuel cell. The fuel off gas in the circulation system contains generated water, which has been generated from an electrochemical reaction in the fuel cell. The circulation system has a gas-liquid separator which separates the fuel off gas and the generated water. Further, a discharge passage for discharging the generated water to the outside is connected to a water reservoir of the gas-liquid separator, and a discharge valve (drain valve) is installed in the discharge passage.

The discharge passage has a double-piping structure in which the generated water passes through an inner pipe thereof, while cooling water from the fuel cell passes through an outer pipe thereof. With this arrangement, the discharge valve is heated by the cooling water which has been warmed by the exhaust heat of the fuel cell, thereby restraining the water in the discharge valve from freezing even when an external temperature is below zero.

### DISCLOSURE OF THE INVENTION

However, no specific construction of the discharge valve has been disclosed in Japanese Patent Application Laid-Open No. 2006-147440. According to Japanese Patent Application Laid-Open No. 2006-147440, the double piping is built in the discharge valve; however, it is structurally difficult to implement the double piping where the discharge valve allows a passage (the inner pipe) between a valve seat and a valve disc to be closed by the valve disc, while to be covered by the outer pipe. Even if such a construction is possible, the structure around the valve seat would be extremely complicated.

An object of the present invention is to provide a fuel cell system capable of raising the temperature of a discharge valve so as to restrain freezing in the discharge valve by a simple structure.

To achieve the above object, a fuel cell system of the present invention comprises a circulation system which circulate a fuel off gas discharged from a fuel cell to the fuel cell; a discharge valve which discharges a fluid in the circulation system to the outside; and a refrigerant flow path through which a refrigerant is circulated to the fuel cell flows. Further, the discharge valve has a valve body provided with a flow path which interconnects the interior of the circulation system and the outside, and a part of the refrigerant flow path penetrates the valve body so as to be independent of the aforesaid flow path.

With this arrangement, the refrigerant flows directly into the valve body, thus allowing the temperature of the valve body to be raised by thermal conduction. This makes it possible to restrain freezing in the flow path for discharging a fluid. Further, the part of the flow path for discharging a fluid and the refrigerant flow path are independent in the valve body, thus allowing the structure of the discharge valve to be simplified.

Preferably, the discharge valve may have a valve seat and a valve disc which moves away from or into contact with the valve seat to open or close the flow path for discharging a fluid, and the part of the refrigerant flow path may be provided by penetrating a portion of the valve body near the valve seat.

With this arrangement, the refrigerant can be passed near the valve seat, thus making it possible to intensively heat the valve seat involved in freezing.

Another fuel cell system in accordance with the present invention comprises a circulation system, a discharge valve, and a refrigerant flow path, as with the case described above. Further, a pipe constituting the refrigerant flow path contacts a surface of a valve body of the discharge valve through a thermally-conductive member.

With this arrangement, the heat of a refrigerant flowing through the refrigerant flow path can be transferred to the valve body from the pipe via the thermally-conductive member. Thus, the temperature raising performance of the discharge valve can be improved and the freezing in the flow path for discharging a fluid can be restrained by the simple structure.

Preferably, the thermally-conductive member may be a stay which secures the pipe of the refrigerant flow path to the valve body.

This arrangement allows a single member to serve as the member for securing the pipe of the refrigerant flow path and also as the member for transferring heat from the refrigerant flow path to the valve body. This permits a simple and compact structure in the neighborhood of the discharge valve.

Preferably, the fuel cell may be formed of a fuel cell stack constituted by stacking unit cells, and the valve body may be secured to the fuel cell stack at one point.

With this arrangement, there is only one heat bridge through which heat escapes from the valve body to the fuel cell stack, thus making it possible to restrain the heat dissipation from the valve body to the fuel cell stack. Hence, the temperature rise of the valve body can be enhanced.

In another preferred mode, the valve body may be bolted to the fuel cell stack through a bracket. The bracket may be spaced away from the fuel cell stack except for a portion bolted to the fuel cell stack.

This arrangement allows the area of the heat bridge to be reduced, also permitting enhanced temperature rise of the valve body.

Preferably, the valve body may be secured to an end plate of the fuel cell stack.

In general, the end plate is provided with a connection for joining the refrigerant flow path to the interior of the fuel cell stack. Therefore, securing the valve body to the end plate permits effective use of the end plate in placing the discharge valve on the fuel cell stack.

### BRIEF DESCRIPTION OF THE DRAWINGS

FIG. 1 is a block diagram illustrating a main section of a fuel cell system according to an embodiment.

FIG. 2 is a top plan view of an exhaust/drain valve according to the embodiment and a neighborhood thereof.

FIG. 3 is a side view of the exhaust/drain valve according to the embodiment and a neighborhood thereof, as observed from the direction of III in FIG. 2.

FIG. 4 is a sectional diagram taken at IV-IV in FIG. 2.

FIG. 5 is a sectional diagram taken at V-V in FIG. 4.

FIG. 6 is a top plan view of an exhaust/drain valve according to a modification example and a neighborhood thereof.

FIG. 7 is a top plan view of an exhaust/drain valve according to a modification example and a neighborhood thereof.

FIG. 8 is a top plan view of an exhaust/drain valve according to a modification example and a neighborhood thereof.

FIG. 9 is a side view of an exhaust/drain valve according to a second embodiment and a neighborhood thereof.

### BEST MODE FOR CARRYING OUT THE INVENTION

The following will describe a fuel cell system in accordance with preferred embodiments of the present invention with reference to the accompanying drawings.

### First Embodiment

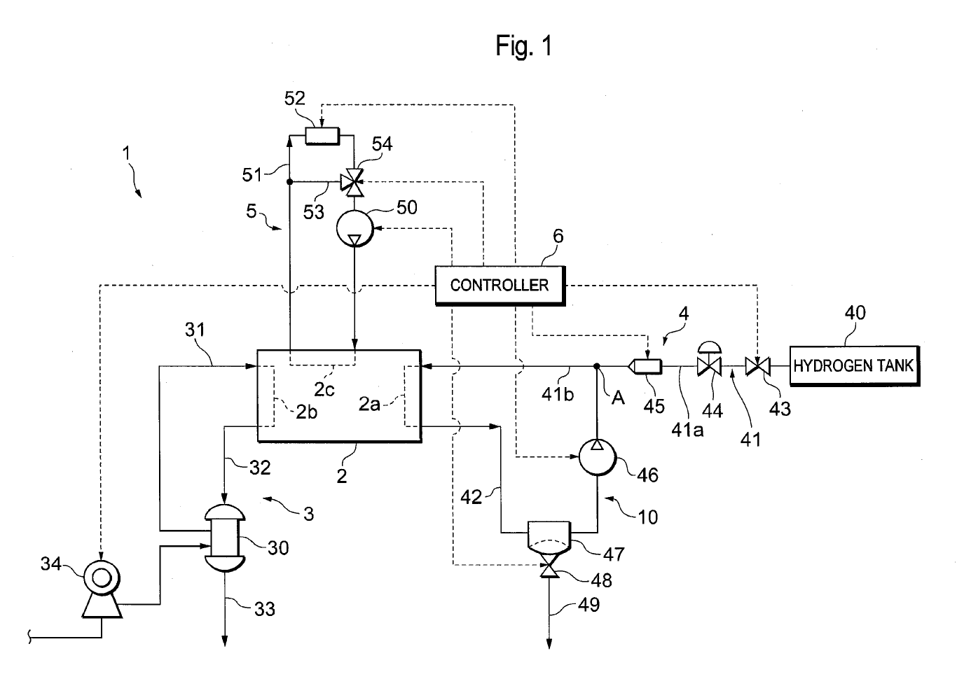

A fuel cell system 1 illustrated in FIG. 1 is a vehicle-mounted electric power generating system for a fuel cell vehicle. The fuel cell system 1 can be applied to an electric power generating system for any type of mobile body, such as a marine vessel, an airplane, a train, or a walking robot, and can be further applied to a fixed electric power generating system or the like used as electric power generating equipment for a building, a house, or the like.

As illustrated in FIG. 1, the fuel cell system 1 has a fuel cell 2, an oxidizing gas piping system 3, a fuel gas piping system 4, a refrigerant piping system 5, and a controller 6.

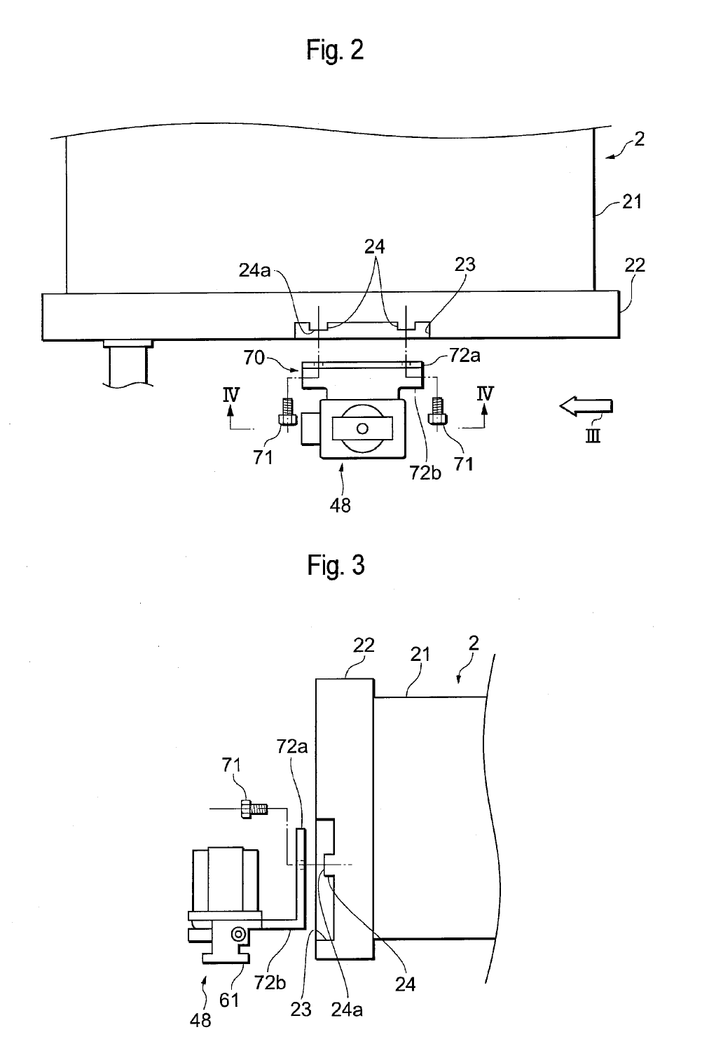

The fuel cell 2 is, for example, a solid polyelectrolyte type. As illustrated in FIGS. 2 and 3, the fuel cell 2 has a stack body 21 which is formed by stacking multiple unit cells, and also has a terminal plate with an output terminal, an insulating plate, and an end plate 22 stacked in sequence on the outer side of unit cells at both ends of the stack body 21. The end plate 22 is provided with a fluid piping connection for supplying and discharging various types of fluids (an oxidizing gas, a fuel gas, and a refrigerant) into and from the stack body 21. Incidentally, the terminal plate and the insulating plate are not shown in FIGS. 2 and 3.

Each of the unit cells has an air electrode on one surface of an electrolyte membrane, a fuel electrode on the other surface thereof, and a pair of separators sandwiching the air electrode and the fuel electrode from both sides. A fuel gas is supplied to a fuel gas passage 2a of one separator, while an oxidizing gas is supplied to an oxidizing gas passage 2b of the other separator. Further, a refrigerant is supplied to a refrigerant passage 2c between the separators. An electrochemical reaction takes place in the unit cell to which the oxidizing gas and the fuel gas have been supplied, thus causing the unit cell to generate electric power. The electrochemical reaction also generates water at the air electrode. A part of the generated water may permeate the electrolyte membrane and move toward the fuel electrode. The electrochemical reaction in the solid polyelectrolyte type fuel cell 2 is a heat-generating reaction, but the supply of the refrigerant maintains the temperature of the fuel cell 2 at approximately 60 to 70° C.

The oxidizing gas and the fuel gas are generically referred to as reactant gases. In particular, the oxidizing gas and the fuel gas discharged from the fuel cell 2 are referred to as an oxidizing off gas and a fuel off gas, respectively, and these are generically referred to as reactant off gases. In the following description, air will be taken as an example of the oxidizing gas and a hydrogen gas as an example of the fuel gas. The fuel off gas will be referred to as the hydrogen off gas.

The oxidizing gas piping system 3 supplies and discharges the oxidizing gas to and from the fuel cell 2. The oxidizing gas piping system 3 has a humidifier 30, a supply flow path 31, a discharge flow path 32, an exhaust flow path 33, and a compressor 34. The compressor 34 is provided at an upstream end of the supply flow path 31. The air in the atmosphere introduced by the compressor 34 is pressure-fed to the humidifier 30 through the supply flow path 31, humidified by the humidifier 30 and then supplied to the fuel cell 2. The oxidizing off gas discharged from the fuel cell 2 is introduced into the humidifier 30 through the discharge flow path 32, and then flows through the exhaust flow path 33 so as to be discharged to the outside.

The fuel gas piping system 4 supplies and discharges the fuel gas to and from the fuel cell 2. The fuel gas piping system 4 has a hydrogen tank 40, a supply flow path 41, and a circulation flow path 42.

The hydrogen tank 40 is a hydrogen supply source storing a hydrogen gas of a high pressure (e.g., 70 MPa). In place of the hydrogen tank 40, a combination of a reformer which generates a hydrogen-rich reformed gas from a hydrocarbon-based fuel and a high-pressure gas tank which places a reformed gas, which has been generated by the reformer, in a high-pressure state and accumulates the high-pressure reformed gas may be adopted as a hydrogen supply source. Further, in place of the hydrogen tank 40, a tank having a hydrogen storing alloy may be adopted.

The supply flow path 41 is a flow path for supplying the hydrogen gas in the hydrogen tank 40 to the fuel cell 2, and consists of a main flow path 41a and a mixing flow path 41b, a merging point A being the boundary thereof. The main flow path 41a is provided with a shut valve 43, a regulator valve 44, and an injector 45. The shut valve 43 functions as a supply valve of the hydrogen tank 40. The regulator valve 44 reduces the gas pressure of the hydrogen gas to a preset secondary pressure. The injector 45 is an electromagnetically driven on-off valve and adjusts with high accuracy the flow rate or the pressure of the hydrogen gas supplied to the mixing flow path 41b.

The circulation flow path 42 is a return pipe for returning the hydrogen off gas discharged through a hydrogen gas outlet of the fuel cell 2 back to the supply flow path 41. The hydrogen pump 46 pressurizes the hydrogen off gas in the circulation flow path 42 and pressure-feeds the hydrogen off gas to the merging point A. At the merging point A, the new hydrogen gas from the hydrogen tank 40 and the hydrogen off gas from the hydrogen pump 46 are merged, and the mixed hydrogen gas after the merging is passed through the mixing flow path 41b and supplied to the fuel cell 2. Thus, the remaining hydrogen in the hydrogen off gas is recycled for the electric power generation in the fuel cell 2.

The circulation flow path 42 is connected to a discharge flow path 49 through a gas-liquid separator 47 and an exhaust/drain valve 48 provided on the upstream side of the hydrogen pump 46. The hydrogen off gas passing through the circulation flow path 42 contains the moisture of generated water and a nitrogen gas which have permeated through the electrolyte membrane to the fuel electrode, although the quantities thereof are extremely small, as compared with the quantity of the hydrogen off gas. The gas-liquid separator 47 separates a liquid (moisture) and a gas (hydrogen off gas) in the hydrogen off gas, and temporarily retains the separated moisture. The retained moisture is discharged from the exhaust/drain valve 48 into the discharge flow path 49 so as to be discharged to the outside. Further, a part of the hydrogen off gas after the moisture has been collected is also discharged into the discharge flow path 49 from the exhaust/drain valve 48 so as to be discharged to the outside.

Thus, the exhaust/drain valve 48 functions not only as a drain valve for discharging the water as the fluid flowing in the circulation system 10 to the outside but also functions as an exhaust valve for discharging the hydrogen off gas containing impurities to the outside. When the exhaust/drain valve 48 is opened, the generated water accumulated in the gas-liquid separator 47 can be drained and the concentration of the hydrogen in the hydrogen off gas can be increased. The specific structures of the exhaust/drain valve 48 and the neighborhood thereof will be described later.

The downstream end of the discharge flow path 49 may be directly open to the atmosphere, or may be connected to a diluter, which is not shown, or the exhaust flow path 33. Further, the circulation system 10 is a system in which the circulation flow path 42, the mixing flow path 41, and the fuel gas passage 2a are joined in sequence, and circulates the hydrogen off gas back to the fuel cell 2.

The refrigerant piping system 5 circulates a refrigerant (e.g., cooling water) to the fuel cell 2. The refrigerant piping system 5 has a cooling pump 50, a refrigerant flow path 51, a radiator 52, a bypass flow path 53, and a switching valve 54. The cooling pump 50 pressure-feeds the refrigerant in the refrigerant flow path 51 to circulate the refrigerant to the refrigerant passage 2c. The end of the piping of the refrigerant flow path 51 is joined to a connection of the end plate 22. Further, as will be described later, the exhaust/drain valve 48 is heated by a part of the refrigerant flow path 51. The radiator 52 cools the refrigerant discharged from the fuel cell 2. The switching valve 54 switches the flow of cooling water between the radiator 52 and the bypass flow path 53, as necessary.

The controller 6 is constituted as a microcomputer incorporating a CPU, a ROM, and a RAM. The controller 6 receives detected information from a current sensor and also detected information of sensors for detecting the pressures, the temperatures, the flow rates and the like of fluids passing through the piping systems. Then, the controller 6 controls various types of equipment (the compressor 34, the shut valve 43, the injector 45, the hydrogen pump 46, the exhaust/drain valve 48, the cooling pump 50, the switching valve 54, and the like) in the system 1 according to the aforesaid detected information or a required amount of electric power to be generated in the fuel cell 2, and carries out a purging operation or the like in the circulation system 10.

A description will now be given of the constructions of the exhaust/drain valve 48 and the neighborhood thereof.

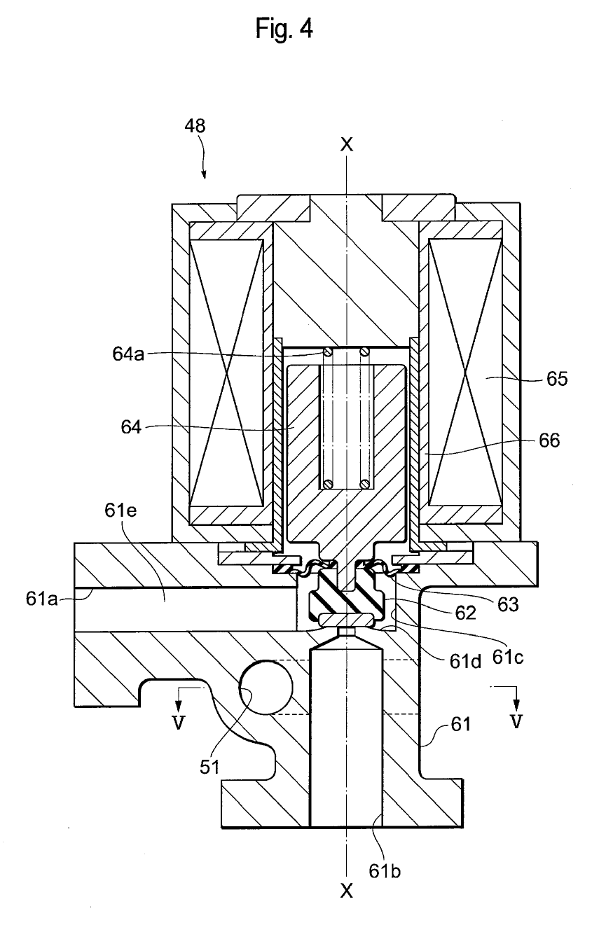

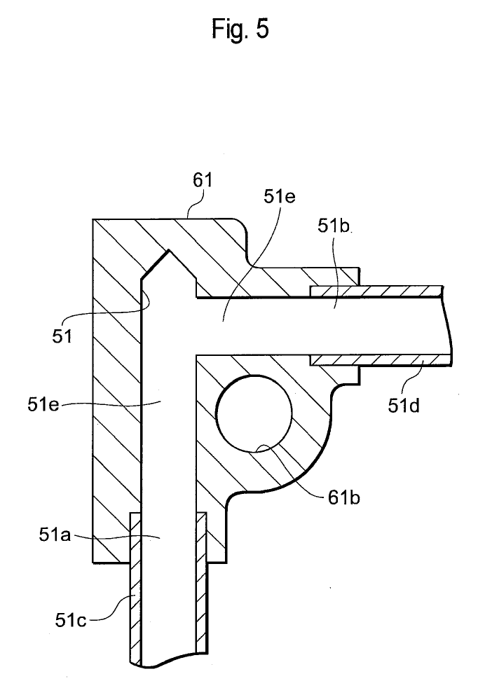

As illustrated in FIGS. 4 and 5, the exhaust/drain valve 48 (discharge valve) is an electromagnetically driven on-off valve and actuated by control signals from the controller 6 to intermittently release a fluid in the circulation system 10 to the discharge flow path 49. The exhaust/drain valve 48 has an angle-valve structure and comprises a valve body 61, a valve seat 61d, and a valve disc 62.

In the valve body 61, an inflow channel 61a, an outflow channel 61b, and a valve chest 61c are formed as a flow path 61e for the fluids (the water and the hydrogen off gas) discharged from the gas-liquid separator 47. The inflow channel 61a is in communication with the circulation flow path 42 through the gas-liquid separator 47, while the outflow channel 61b is in communication with the outside through the discharge flow path 49. The valve seat 61d is formed on the bottom surface of the valve chest 61c and has an opening, which is in communication with the outflow channel 61b.

The valve disc 62 is provided in the valve chest 61c such that the valve disc 62 is movable within a predetermined stroke in the direction of an axis line X-X. The valve disc 62 abuts against the valve seat 61d to close the opening of the valve seat 61d so as to close the flow path 61e. On the other hand, when the valve disc 62 moves away from the valve seat 61d, the opening of the valve seat 61d is released so as to open the flow path 61e. A diaphragm 63 is provided between the outer surface of the valve disc 62 and an edge of the valve chest 61c and constructed so as to follow the movement of the valve disc 62.

A plunger 64 has the valve disc 62 secured to the distal end thereof, and is biased toward the valve seat 61d by a spring 64a. The plunger 64, a coil 65 and an iron core 66 constitute a drive unit of a solenoid type actuator for reciprocating the valve disc 62 at a predetermined stroke in the direction of the axis line X-X. Turning ON or OFF the supply of current to the coil 65 of the drive unit basically causes the exhaust/drain valve 48 to be switched between two positions, namely, “open” and “close” thereby to intermittently discharge the fluids (the water and the off gas), which are discharged from the gas-liquid separator 47, to the discharge flow path 49.

The exhaust/drain valve 48 is provided with, in addition to the aforesaid general structures, a structure which is heated by the refrigerant piping system 5. More specifically, a part of the refrigerant flow path 51 penetrates the valve body 61. The refrigerant flow path 51 is formed in a portion of the valve body 61, which portion does not intersect with the inflow channel 61a, the outflow channel 61b, and the valve chest 61c, such that the refrigerant flow path 51 is independent of or does not interfere with the flow path 61e. The valve body 61 has the inlet 51a and an outlet 51b of a refrigerant formed therein, and pipes 51c and 51d of the refrigerant flow path 51 outside the valve body 61 are connected to the inlet 51a and the outlet 51b. A flow path 51e connecting the inlet 51a and the outlet 51b is an L-shaped flow path passing aslant below the valve chest 61c, and formed such that the flow path 51e penetrates a portion, which is relatively near the valve chest 61c and the valve seat 61d, so as to surround the outflow channel 61b from two directions.

With this arrangement, when the refrigerant flows through the refrigerant flow path 51 at a low temperature, the heat of the refrigerant is promptly transferred to the valve chest 61c and the valve seat 61d, thus intensively heating the valve chest 61c and the valve seat 61d. This restrains water from freezing at the valve chest 61c and the valve seat 61d. Further, the flow path 51e for the refrigerant and the flow path 61e for the hydrogen off gas or the like are independent in the valve body 61, thus accomplishing an extremely simple structure of the exhaust/drain valve 48, as compared with the double piping structure. Moreover, since the freezing in the flow path 61e can be restrained, the flow path 61e does not require a large diameter to prevent freezing, thus making it possible to reduce the size and the weight of the exhaust/drain valve 48. In addition, the inlet 51a and the outlet 51b of the refrigerant are provided in different directions from the inlet of a fluid into the inflow channel 61a and the outlet of a fluid from the outflow channel 61b, permitting easy routing of pipes outside the valve body 61.

Here, the refrigerant flowing in the valve body 61 is preferably the refrigerant before flowing into the radiator 52. This is because the temperature of the refrigerant is lowered by the radiator 52; therefore, in order to raise the temperature of the exhaust/drain valve 48 more promptly, it is better to use the refrigerant before its temperature is lowered.

However, in the case where a low-efficiency operation is performed in a low-temperature environment wherein the temperature of the exhaust/drain valve 48 is below a water-freezing temperature, control may be conducted such that the refrigerant flows into the bypass flow path 53, bypassing the radiator 52. This reduces the difference between the temperature of the refrigerant at a supply end and that at a discharge end of the fuel cell 2, so that either the refrigerant at the supply end or the refrigerant at the discharge end of the fuel cell 2 may be allowed to flow into the valve body 61. This is because there is no significant difference in the effect for raising the temperature of the valve body 61.

As described above, according to the fuel cell system 1 of the present embodiment, the simple structure allows a refrigerant to circulate through the exhaust/drain valve 48 and also allows the circulation position to be set in the vicinity of the valve seat 61d. Thus, the exhaust heat of the fuel cell 2 can be used to raise the temperature of the exhaust/drain valve 48 and the freezing of the flow path 61e for the hydrogen off gas or the like can be restrained. In particular, when the fuel cell system 1 is started up in a low-temperature environment at below-zero temperatures or the like, even if the flow path 61e is partly frozen, the temperature of the exhaust/drain valve 48 can be promptly raised, making it possible to eliminate the partial freezing.

Control may be conducted such that the refrigerant is supplied to the valve body 61 only when the temperature is low, e.g., below zero. In this case, the controller 6 may set the circulation by the switching valve 54 such that the refrigerant is supplied to the valve body 61 only in a predetermined low-temperature environment wherein the temperature is below zero or the like according to an external temperature sensor or the like, which is not shown.

The following will describe modification examples of the embodiment described above. The description of like aspects as those in the embodiment above will be omitted, and only different aspects will be described.

The exhaust/drain valve 48 may be provided at a position apart from the fuel cell 2, that is, at a position apart from the end plate 22 (refer to FIG. 1). Meanwhile, the exhaust/drain valve 48 may be secured to the end plate 22.

However, simply securing the exhaust/drain valve 48 to the end plate 22 would cause the end plate 22 to take considerable heat from the exhaust/drain valve 48, the temperature of which is rising. It would be likely to adversely affect the rise of the temperature of the exhaust/drain valve 48. Therefore, the following will explain two examples of a preferred method for securing the exhaust/drain valve 48 so as to restrain heat dissipation to the end plate 22.

### First Example

FIG. 2 is a diagram illustrating the plane configurations of an end portion of the stack body 21 and the exhaust/drain valve 48, and FIG. 3 is a side view observed from direction III in FIG. 2. Incidentally, FIGS. 2 and 3 illustrate simplified configurations of the stack body 21 and the exhaust/drain valve 48, the detailed portions thereof being omitted.

As illustrated in FIG. 2 and FIG. 3, the exhaust/drain valve 48 is secured to the end plate 22 by a bolt 71 (a fastening member) through a bracket 70. The bracket 70 has a first plate-like member 72a extending in parallel to a surface of the end plate 22 and a second plate-like member 72b extending at a right angle from a bottom end of the first plate-like member 72a. The first plate-like member 72a is secured to the end plate 22 by the bolt 71, and the second plate-like member 72b is secured to the valve body 61 of the exhaust/drain valve 48.

The end plate 22 has a spot facing 23 formed adjacently to the surface of the first plate-like member 72a. The spot facing 23 is shaped to be larger than the contour of the first plate-like member 72a, and a bottom surface 23a thereof has a bearing portion 24 protruding toward the first plate-like member 72a. The bearing portion 24 is formed at a position corresponding to the position of a bolt hole of the first plate-like member 72a, and a bearing surface 24a is formed around a fastening hole into which the bolt 71 is screwed in. When the valve body 61 is secured to the end plate 22 through the bracket 70, the portion of the bracket 70 which is in contact with the end plate 22 is only the portion of the bearing surface 24a.

According to the first example, the bracket 70 is spaced away from the end plate 22 except for the portion bolted to the end plate 22. In other words, the contact surface between the bracket 70 and the end plate 22 is only the bearing surface 24a, which has a small area. This makes it possible to restrain the heat dissipation from the valve body 61 to the end plate 22.

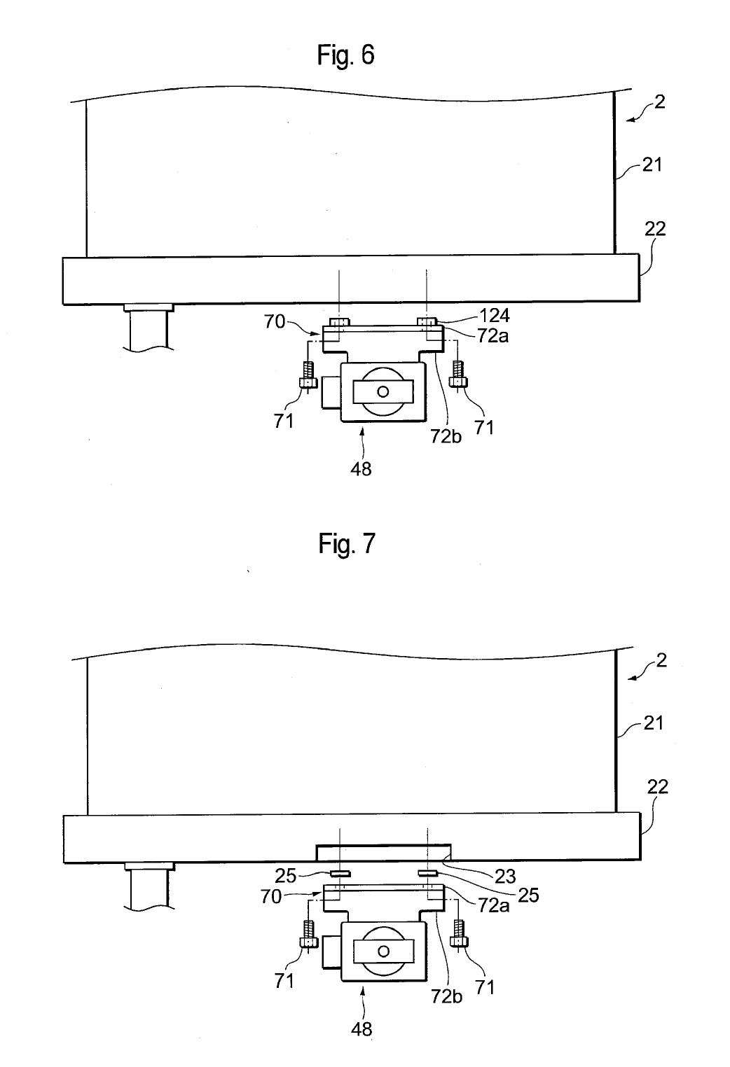

A modification example of the first example may be, for instance, a mode illustrated in FIG. 6 or FIG. 7. To be specific, as illustrated in FIG. 6, a bearing portion 124 may be provided on the first plate-like member 72a of the bracket 70, while omitting the spot facing 23 and the bearing portion 24. This arrangement also reduces the area of the contact surface, which provides a thermal conduction route from the valve body 61 to the end plate 22, as with the construction described above. Hence, the heat dissipation from the valve body 61 to the end plate 22 can be restrained.

Further, as illustrated in FIG. 7, a washer 25, such as a spring washer or a lock washer, may be provided between the first plate-like member 72a and the end plate 22, while omitting the bearing portion 24. This construction also reduces the areas of the contact surface between the washer 25 and the first plate-like member 72a and of the contact surface between the washer 25 and the end plate 22, as with the construction described above. Thus, the thermal conduction area is reduced in a like manner, making it possible to restrain the heat dissipation from the exhaust/drain valve 48, the temperature of which is rising.

In any one case of the first example, the bracket 70 may be formed integrally with the valve body 61.

### Second Example

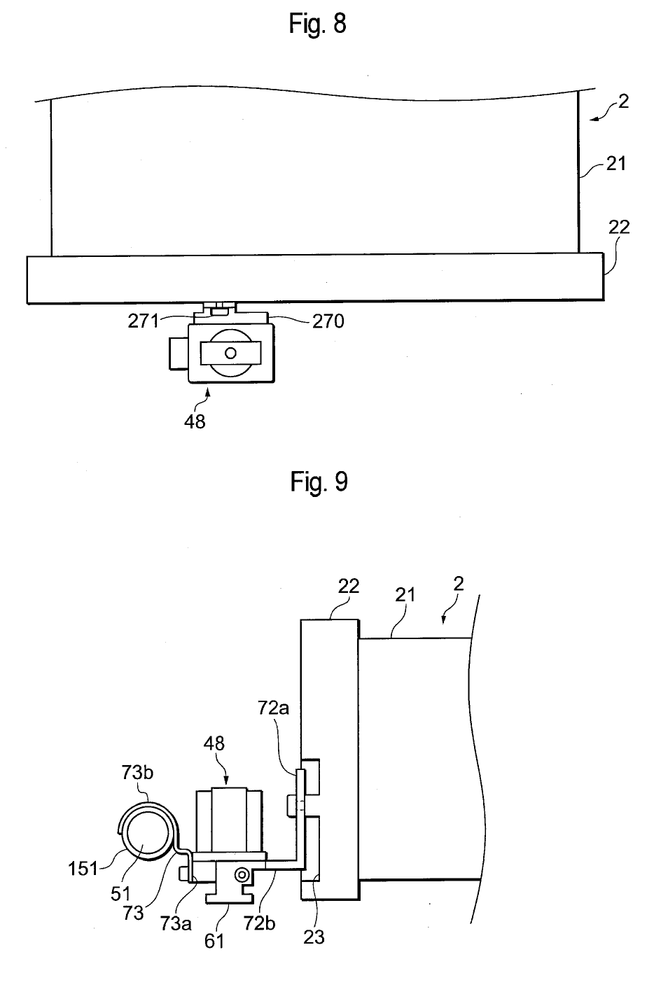

FIG. 8 is a diagram illustrating the plane configurations of an end portion of the stack body 21 and the exhaust/drain valve 48 similar to those in FIG. 2. In the present example, the exhaust/drain valve 48 is secured to the end plate 22 at only one point. More specifically, the exhaust/drain valve 48 is secured to a bracket 270, and the bracket 270 is secured to the end plate 22, the bracket 270 and the end plate 22 being fastened at one point by a single bolt 271. The fastening at one point makes it possible to reduce the amount of heat transferred from the exhaust/drain valve 48, whose temperature is rising, to the end plate 22, thus expediting the rise of the temperature of the exhaust/drain valve 48.

The one-point fastening is preferably positioned at the center of gravity of the exhaust/drain valve 48 or in the vicinity thereof. This allows the exhaust/drain valve 48 to be stably supported by the end plate 22 even if the exhaust/drain valve 48 should be subjected to a vibration or an impact due to an external force. Incidentally, the bracket 270 may be integrally formed with a valve body 61.

### Second Embodiment

Referring now to FIG. 9, a second embodiment of the present invention will be described regarding major different aspects. A different aspect from the first embodiment is that the refrigerant flow path 51 is provided in contact with the outer surface of the valve body 61 rather than a part of the refrigerant flow path 51 penetrating the valve body 61. Components that are common with those of the first embodiment will be assigned like reference numerals and detailed explanation thereof will be omitted.

A pipe 151 of the refrigerant flow path 51 is disposed near the valve body 61 and secured to the valve body 61 through a stay 73 (a thermally-conductive member). The stay 73 is a plate-like member, such as a metal member, having thermal conductivity. One end 73a of the stay 73 contacts with the surface of the valve body 61 and is secured thereto by a bolt or the like. The surface of the valve body 61 with which the one end 73a contacts is preferably near a valve chest 61c or a valve seat 61d. Further, the other end 73b of the stay 73 is provided such that the other end 73b contacts with the surface of the pipe 151. The other end 73b has, for example, an approximately semi-arcuate section, and contacts with the pipe 151 such that the other end 73b covers the half of the outer peripheral surface of the pipe 151. This arrangement makes it possible to secure certain sizes of an area of contact between the stay 73 and the valve body 61 and an area of contact between the stay 73 and the pipe 151.

According to the second embodiment, the plate surface of the stay 73 contacts with the valve body 61 and the pipe 151, so that the heat of a refrigerant flowing through the refrigerant flow path 51 is transferred from the pipe 151 to the stay 73 and then from the stay 73 to the valve body 61. Thus, the structure, which is simpler than that of the first embodiment, makes it possible to improve the performance for raising the temperature of the exhaust/drain valve 48 and to restrain the exhaust/drain valve 48 from freezing.

As with the first embodiment, the refrigerant flowing through the pipe 151 may be any refrigerant before flowing into a radiator 52, and in the case of performing a low-efficiency operation, the refrigerant may be either the refrigerant at the supply side or the one at the discharge side of the fuel cell 2. Further, the shape and the securing position of the stay 73 may be designed such that the stay 73 does not interfere with other members provided around the valve body 61 and that the neighborhood of the exhaust/drain valve 48 is simple and compact.

### INDUSTRIAL APPLICABILITY

The exhaust/drain valve 48 may be adapted to perform only exhaust or drainage. For example, in the case where a drain valve for discharging water, which has been separated by the gas-liquid separator 47, to the outside and an exhaust valve for discharging the hydrogen off gas in the circulation flow path 42 to the outside together with impurities are provided separately, adopting the same construction as that of the exhaust/drain valve 48 for each of the drain valve and the exhaust valve makes it possible to restrain these valves from freezing. In such a construction, the drain valve is connected to the gas-liquid separator 47 in the same manner as that of the exhaust/drain valve 48. Meanwhile, the exhaust valve is installed in a purge channel which is branched and connected to the circulation flow path 42.

1. (canceled)

2. A fuel cell system comprising:
a circulation system that circulates a fuel off gas, which is discharged from a fuel cell, to the fuel cell;
a discharge valve which discharges a fluid from the circulation system to the outside; and
a refrigerant flow path through which a refrigerant, which is circulated to the fuel cell, flows,
wherein the discharge valve has a valve body provided with a fluid discharge flow path which interconnects the interior of the circulation system and the outside, a valve seat in the valve body, and a valve disc which moves away from or comes in contact with the valve seat so as to open or close the flow path, and
a part of the refrigerant flow path is provided by penetrating a portion of the valve body, the portion being in the vicinity of the valve seat and also in the vicinity of the flow path.

3. The fuel cell system according to claim 2, wherein the part of the refrigerant flow path extends in an L shape in the valve body such that the part surrounds the flow path from two directions.

4. The fuel cell system according to claim 2, wherein the valve body has an inlet and an outlet for the refrigerant flow path, and an inlet and an outlet for the flow path which are provided in directions different from those of the inlet and the outlet for the refrigerant flow path.

5. A fuel cell system comprising:
a circulation system that circulates a fuel off gas, which is discharged from a fuel cell, to the fuel cell;
a discharge valve that discharges a fluid from the circulation system to the outside; and
a refrigerant flow path through which a refrigerant, which is circulated to the fuel cell, passes,
wherein the discharge valve has a valve body provided with a flow path which interconnects the interior of the circulation system and the outside, and
the valve body has a valve seat and a valve chest, which constitutes a part of the flow path,
a pipe constituting the refrigerant flow path contacts the valve body through a thermally-conductive member, and
a portion where the thermally-conductive member is in contact with the valve body is in the vicinity of the valve chest or the valve seat.

6. The fuel cell system according to claim 5, wherein the thermally-conductive member is a stay which secures the pipe to the valve body.

7. The fuel cell system according to claim 2, wherein the fuel cell is formed of a fuel cell stack constituted by stacking unit cells, and
the valve body is secured to the fuel cell stack at one point.

8. The fuel cell system according to claim 2, wherein the fuel cell is formed of a fuel cell stack constituted by stacking unit cells,
the valve body is bolted to the fuel cell stack through a bracket, and
the bracket is spaced away from the fuel cell stack except for a portion bolted to the fuel cell stack.

9. The fuel cell system according to claim 7, wherein the valve body is secured to an end plate of the fuel cell stack.

10. The fuel cell system according to claim 5, wherein the fuel cell is formed of a fuel cell stack constituted by stacking unit cells, and
the valve body is secured to the fuel cell stack at one point.

11. The fuel cell system according to claim 5, wherein the fuel cell is formed of a fuel cell stack constituted by stacking unit cells,
the valve body is bolted to the fuel cell stack through a bracket, and
the bracket is spaced away from the fuel cell stack except for a portion bolted to the fuel cell stack.

12. The fuel cell system according to claim 11, wherein the valve body is secured to an end plate of the fuel cell stack.

13. The fuel cell system according to claim 10, wherein the valve body is secured to an end plate of the fuel cell stack.

14. The fuel cell system according to claim 8, wherein the valve body is secured to an end plate of the fuel cell stack.
